(19) United States
(12) Patent Application Publication
(10) Pub. No.: US 2006/0010503 A1
(43) Pub. Date: Jan. 12, 2006

(54) Product authentication system for preventing distribution of counterfeits in market

(76) Inventors: Yoshiaki Inoue, Kashima-gun (JP); Yuichi Yoshikawa, Kashima-gun (JP)

Correspondence Address: PITNEY HARDIN LLP, 7 TIMES SQUARE, NEW YORK, NY, 10036-7311, US

(21) Appl. No.: 10/519,733

(22) PCT Filed: Feb. 18, 2004
(86) PCT No.: PCT/IB04/00402

§ 371 Date: Aug. 4, 2005

(30) Foreign Application Priority Data
Feb. 19, 2003 (JP) 2003-40692

(51) Int. Cl. G06F 17/30; G06F 7/04; G06K 9/00; H03M 1/68; H04K 1/00; H04L 9/00; H04L 9/32; H04N 7/16

(52) U.S. Cl. 726/30; 713/189

(57) ABSTRACT

By means of preventing counterfeits on the market from entering a distribution channel, the benefit of manufacturers, dealers, distributors, and consumers forming the distribution channel. First, a data server reads ID data of a non-contact tag 11 and of a reader 12, creates data files thereof, and stores the data files in a database. The reader 12 connected to the Internet reads its own ID data and sends it to an authentication server. The authentication server checks the received ID data of the reader 12 against the data file of the reader 12 stored in the database. If the two are identical, the reader is authenticated. The authenticated reader 12 reads the ID data of the non-contact tag 11 embedded in a product and sends it to the authentication server. The authentication server checks the received ID data of the non-contact tag 11 against the data file of the non-contact tag stored in the database. If, as a result, the two are identical, the authentication server notifies the reader 12 that the non-contact tag is authenticated. The product authentication system is administered and operated by an application service provider (ASP) entity 10.

### TECHNICAL FIELD OF THE INVENTION

The present invention relates to a product authentication system for providing in an ASP system product authentication service at a distribution stage for the purpose of protecting, by means of preventing counterfeits on the market from entering the distribution channel, the benefit of manufacturers, dealers, distributors, and consumers forming the distribution channel.

### DESCRIPTION OF THE RELATED ART

When consumers purchase a product which adorns themselves such as a wrist watch, a bag, or clothing, who manufactured the product is an important decisive factor in selecting the product. The value such a product which adorns consumers should have is not only that the product satisfies a required function but also that the product is excellent as a means for self-actualization. A brand is value added to a product in that it can directly represent particularities of a person who buys the product. Therefore, a manufacturer having a strong brand applies an original unified design on its products or intentionally provides a registered trademark or a logo at a conspicuous location of its products, so that it is made clear at a glance that the product is manufactured by the manufacturer. A consumer who buys the product can shows off the brand of the manufacturer to represent his/her particularities just by carrying the product with him/her. In the context of such a trend in consumption, manufacturers, for the purpose of increasing their market shares, have put efforts into enhancing their brand power to increase the added value of their products.

However, on the other hand, by taking advantage of such a trend in consumption, counterfeits manufactured so as to be just like high-value-added brands are sometimes on the market and sold at lower prices and in high volume. As the copying technology of counterfeits becomes sophisticated and their distribution channel is shrewdly formed evading control, counterfeits take market share away from genuine products in the market of brands. Manufacturers of such products suffer from heavy economic losses, because, not only the sales of their products are hurt, but also, for example, troubles caused by counterfeits damage the credibility of the brand and considerably degrade the value of the brand.

Further, dealers and distributors who cannot tell counterfeits deal with counterfeits, thinking that the counterfeits are genuine products. Detection that the products dealt with by such dealers and distributors are counterfeits leads to a large amount of dead stock. When they have already sold such counterfeits, they have to recall the counterfeits from those who have purchased the counterfeits, change the counterfeits for genuine products, or the like, as a guarantee for the purchaser. In this way, such dealers and distributors suffer from heavy economic losses.

Further, consumers who can not tell counterfeits and who have purchased counterfeits thinking that they are genuine products also suffer from economic losses when they purchase the counterfeits abroad during their travel and the like. Even if what they have purchased is revealed to be counterfeits after the purchase, it is difficult to negotiate about returning the counterfeits. When troubles such as breakdown are caused after they return home, they can not make what they have purchased returned or changed for genuine products, because they do not know how to contact the dealers, the necessary procedure is complicated, or the like.

As described in the above, counterfeits inflict losses on everyone who forms a distribution channel, i.e., from manufacturers, through dealers and distributors, and to consumers.

Therefore, manufacturers take the following measures in order to discriminate between their own products and counterfeits.

Sometimes products are highly elaborated by the manufacturers as a means for characterizing the products as genuine products. More specifically, the material is embossed, the design is provided with a complicated pattern of shape or color, the products are of elaborate craftsmanship by skilled manual work, a registered trademark or a logo is placed on a specific location, or the like. These not only have the effect of enhancing the added value in design, but also have the effect of preventing counterfeiting by making it technically difficult to imitate their products.

In such a case, whether the product is a genuine one or an counterfeit is discriminated in the following way: when a characterized portion of the product sufficiently looks like that of a genuine product, it is determined to be a genuine product; when the characterized portion of the product does not sufficiently look like that of a genuine product, it is determined to be an counterfeit.

Further, in some cases, manufacturers issue guarantees or warranty cards for guaranteeing their products and attach them on their products. Such guarantees or the like have their respective serial numbers described or inscribed thereon, or, are of elaborate craftsmanship with stamps or watermarks which are technically difficult to imitate.

In such a case, whether the product is a genuine one or an counterfeit is discriminated in the following way: when the product has a guarantee or the like attached thereto and the guarantee or the like sufficiently looks like a genuine guarantee or the like, it is determined to be a genuine product; when the guarantee or the like does not sufficiently look like a genuine guarantee or the like, it is determined to be an counterfeit.

Further, in some cases, manufacturers seal packages of their products with hologram seals or the like which are technically difficult to imitate such that the packages are not easily opened.

In such a case, whether the product is a genuine one or an counterfeit is discriminated in the following way: when there is no trace that a seal for sealing the package of the product was opened, it is determined to be a genuine product; when there is a trace that the seal was opened, it is determined to be an counterfeit.

### SUMMARY OF THE INVENTION

When it is discriminated whether a product is a genuine one or an counterfeit by the conventional methods described in the above and a genuine product is authenticated, there are the following problems.

First, as for representation of elaborate craftsmanship in design, a registered trademark, or the like, if the accuracy of counterfeits is enhanced, the counterfeits can sufficiently look like a genuine product. Therefore, such discrimination requires expertise for discriminating subtle differences, and discriminators have to be trained or employed. But still, if a genuine product and a counterfeit can not be identified, no discrimination can be made.

Further, as for a guarantee attached to a product, similarly, if the accuracy of counterfeits is enhanced, a counterfeit guarantee can sufficiently look like a genuine guarantee. Therefore, if a counterfeit guarantee attached to a counterfeit and a genuine guarantee attached to a genuine product can not be identified, no discrimination can be made between a genuine product and a counterfeit Further, when a guarantee is of elaborate craftsmanship with a stamp or a watermark, expertise for discriminating differences is newly required. Insufficient expertise may be counterproductive, since even a counterfeit which looks like genuine under casual inspection can be easily believed to be genuine.

Further, when a package of a product is sealed with a seal of elaborate craftsmanship, for example, a hologram seal, a purchaser can not open the package prior to purchase and can not examine the content therein, which causes a demerit of leading to decrease in purchasing motivation. Further, manufacture of such seals incurs additional cost. Still further, when such a seal is of elaborate craftsmanship, for example, when such a seal is a hologram seal, expertise for discrimination is newly required as in the case of a guarantee described in the above. With insufficient expertise, even a counterfeit seal which looks like a genuine seal under casual inspection can not be discriminated.

As described in the above, the conventional methods of discriminating differences in the outer appearance by means of manual inspection of a product itself, its guarantee, a seal for sealing its package, or the like require expertise for the discrimination as well as time necessary for the discrimination. Therefore, at a distribution stage, accurate discrimination of a large amount of products at a low cost, without difficulty, at an arbitrary place, and in a short time can not be made.

In view of the above-described conventional problems involved in discrimination between genuine products and counterfeits in a product distribution market, an object of the present invention is to provide a criterion for discrimination between genuine products and counterfeits other than differences in the outer appearance, and, further, to make a discriminating method capable of being performed not as manual work but as a mechanical process and to make available convenient discrimination between genuine products and counterfeits via the Internet for distributors and dealers who deal with products.

According to the present invention, to attain the object as described in the above, a product authentication system is established, wherein a non-contact tag, a reader, a database, a data server, and an authentication server are prepared as hardware for forming the product authentication system.

The non-contact tag is embedded as an authentication device in a product to be authenticated. The non-contact tag has a specific ID known only to an administrator of the product authentication system, the ID being stored in a body of the non-contact tag as electronic data.

The reader reads ID data of the non-contact tag. The reader has a specific ID known only to the administrator of the product authentication system, the ID being stored in a body of the reader as electronic data, and the reader has means for connecting to the Internet for communication.

The database stores the ID data and attribute information data of the non-contact tag, product information data of the product having the non-contact tag embedded therein, and the ID data and attribute information data of the reader, and has means for connecting to the Internet for communication.

The data server reads data stored in the database and writes data into the database, and has means for connecting to the Internet for communication.

The authentication server checks the ID data of the reader and the ID data of the non-contact tag sent from the reader connected to the Internet against data stored in the database to authenticate the reader and the non-contact tag, and has means for connecting to the Internet for communication.

Using such hardware, whether a product is a genuine one or not is discriminated in the following steps.

First, prior to distribution of the non-contact tag and the reader to a user of the product authentication system, the data server reads the ID data of the non-contact tag and the ID data of the reader, creates data files thereof, and stores the data files in the database.

Subsequent to the distribution of the non-contact tag and the reader to the user of the product authentication system, the reader connected to the Internet reads its own ID data and sends it to the authentication server. The authentication server checks the received ID data of the reader against the data file of the reader stored in the database.

The authentication server notifies the reader checked against the identical ID data that the reader is authenticated, and urges the reader to send the ID data of the non-contact tag embedded in the product.

The authenticated reader reads the ID data of the non-contact tag embedded in the product and sends the ID data to the authentication server. The authentication server checks the received ID data of the non-contact tag against the data file of the non-contact tag stored in the database.

The authentication server notifies the reader which sent the ID data of the non-contact tag that the non-contact tag checked against the identical ID data is authenticated.

Further, the above-described product authentication system may be administered and operated by an application service provider (ASP) entity to provide product authentication service via the Internet in an ASP system.

Further, in the above-described product authentication system, when the side of the user is made to have a double ID by assigning to the user of the reader a specific password known only to the administrator and the user of the reader, by adding the following steps, the product authentication system can be made to have a triple checking function as a whole.

The data server creates a data file of data of the assigned password as attribute information related to the ID data of the distributed reader, and stores the data file in the database.

After the reader is notified of its authentication, the authentication server requests input of the password of the user, receives password data inputted and sent from a terminal of the user, and checks said password data against the data file stored in the database.

When check against the identical password data is made, the authentication server notifies the user terminal which sent the password data that the password is authenticated.

Further, the following steps can be added to the above-described product authentication system.

The reader and the user terminal distributed to the manufacturer of the product who is the user of the product authentication system sends to the data server product information data such as the name, the model, the date of manufacture, and the place of manufacture of the product, the product information data being related to the ID data of the non-contact tag.

The data server receives the product information and creates a data file as attribute information related to the ID data of the embedded non-contact tag, and stores the data file in the database.

By adding the above-described steps, when, for example, someone attempts to obtain authentication and to sell a counterfeit by taking off a non-contact tag embedded in an inexpensive genuine product and attaching the non-contact tag to a counterfeit of a more expensive genuine product, such abuse can be prevented by referring to the product information such as the name and the model of the product in addition to the ID of the non-contact tag.

Further, the following steps can be added to the above-described product authentication system.

A manufacturer of the non-contact tag creates a data file where the ID of the non-contact tag is related to the manufacturer of the product who is a supplier of the non-contact tag, and sends the data file to the data server.

The data server receives the data file and stores the data file in the database.

The authentication server receives the ID data of the non-contact tag sent from the reader, and checks whether the ID is related to the supplier in the data file of the non-contact tag stored in the database.

By the above steps, authentication of a product becomes two-step. More specifically, first, whether the ID of the non-contact tag is related to the supplier is checked, and then, whether the ID of the non-contact tag is related to the product information is checked, and thus, a counterfeit can be detected more efficiently, and at the same time, the reliability can be increased.

### BRIEF DESCRIPTION OF THE DRAWINGS

FIG. 1 is a view describing an overview of an embodiment of a product authentication system according to the present invention, and illustrating roles of parties concerned in the system by showing flow of materials and flow of information.

FIG. 2 is a view describing a configuration of hardware necessary for implementing the embodiment of the product authentication system, and showing hardware to be provided for each party concerned.

FIG. 3 is a view describing in detail information processing for implementing the embodiment of the product authentication system with the hardware shown in FIG. 2, and showing contents and directions of information exchanged between pieces of the hardware.

FIG. 4 is a view describing response of the product authentication system when an attempt is made to use the product authentication system without proper authorization compared with a case where the system is used with authorization.

### DETAILED DESCRIPTION OF THE INVENTION

Next, with reference to the drawings, an embodiment of the present invention is described specifically and in detail.

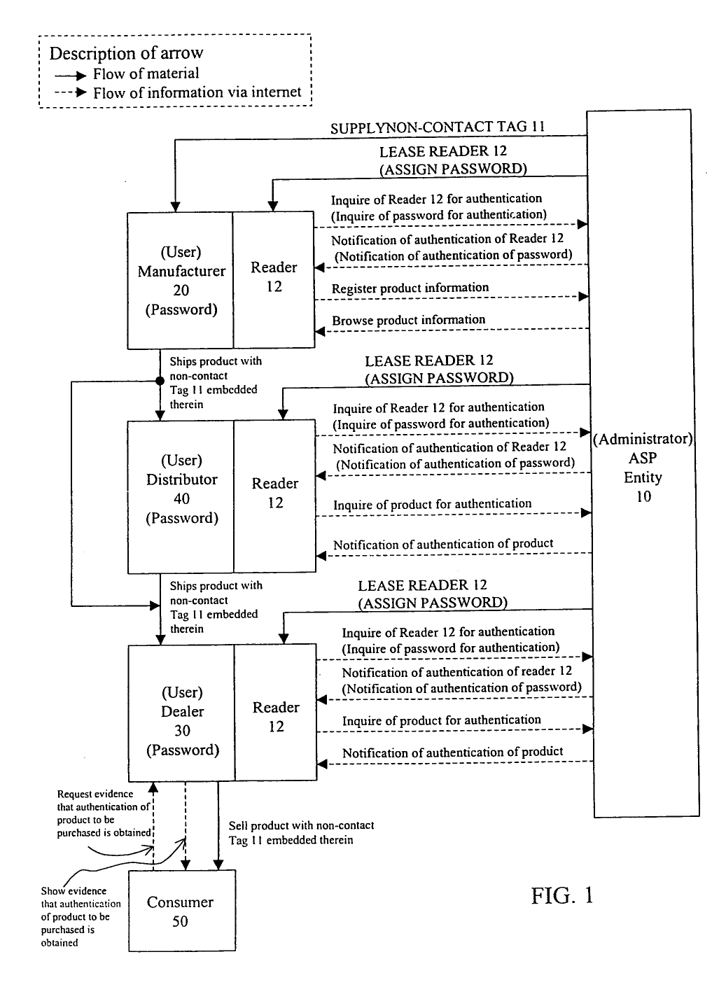

First, an overview of an embodiment of a product authentication system according to the present invention is described with reference to FIG. 1.

Parties concerned in a product authentication system are an ASP entity 10 who is an administrator, and, a manufacturer 20, a dealer 30, a distributor 40, and a consumer 50 who are users. The ASP entity 10 administers a non-contact tag 11 and a reader 12 to administer and operate the product authentication system and provides product authentication service.

The ASP entity 10 supplies the manufacturer 20 with the non-contact tag 11. The non-contact tag 11 has a specific ID, and the ID is stored in a body of the non-contact tag as electronic data. The ASP entity 10 administers ID data of the non-contact tag 11, and data of attribute information such as the name of the manufacturer who is an supplier.

As for the above-described supply of the non-contact tag 11, a manufacturer of the non-contact tag 11 may directly supply the manufacturer 20 with the non-contact tag 11. In this case, the manufacturer of the non-contact tag 11 may create a data file where the ID of the non-contact tag 11 is related to the manufacturer 20 who is the supplier and may provide the data for the ASP entity 10.

As the non-contact tag 11, a super-micro IC chip with a communication function may be used. Such a super-micro IC chip includes one manufactured by Hitachi under the trade name of “μ chip”. The chip measures 0.4 mm both in length and in width, and about 170 μm in thickness, and thus, looks like only a small dot when put on a fingertip. With this size, the chip has a 128-bit memory and a function of communicating by radio waves of 2.45 GHz.

As is known to those skilled in the art, the non-contact tag 11 may be named in different ways, including wireless IC tag, next generation bar code, new generation bar code, ubiquitous ID, wireless IC chip, wireless ID tag, IC tag, non-contact IC tag, IC label, IT tag, non-contact IC card, auto ID, electronic tag, non-contact IC tag, wireless tag, RFID tag, smart tag, non-contact IC chip, etc.

The ASP entity 10 leases to each user of the product authentication service the reader 12 for reading an IC code of the non-contact tag 11. The reader 12 can connect to the Internet via a general-purpose terminal such as a personal computer, and has a specific ID. The ID is stored in a body of the reader as electronic data. The ASP entity 10 administers ID data of the reader 12, and data of attribute information such as the name of the user to whom the reader is leased.

In leasing the reader 12, the ASP entity 10 may make the side of the users have a double ID by assigning a specific password to each user. The ASP entity 10 administers data of the assigned password as attribute information data of the reader 12.

The manufacturer 20 embeds in a product the non-contact tag 11 supplied from the ASP entity 10. By embedding the non-contact tag inside the product so as not to be perceived from the outer appearance, the non-contact tag can be prevented from impairing the appearance of the product and from being taken off and abused. The manufacturer 20 connects its leased reader 12 to the Internet. After the reader 12 is authenticated, the manufacturer 20 registers with the ASP entity 10 product information related to the non-contact tag 11 such as the name, the date of manufacture, and the place of manufacture of the product. The ASP entity 10 administers, in addition to the ID of the non-contact tag 11 and the name of the manufacturer who is the supplier, the product information data registered from the manufacturer 20, the product information data being related to the ID of the non-contact tag 11 and the name of the manufacturer.

After the reader 12 is authenticated, the manufacturer 20 can browse the registered data.

The dealer 30 and the distributor 40 connect their respective leased readers 12 to the Internet. After their respective readers 12 are authenticated, the dealer 30 and the distributor 40 inquire the ASP entity 10 whether a product they deal with is authenticated to be a genuine product. The ASP entity 10 checks the ID data of the inquired non-contact tag 11 against its administered data, authenticates the product, and notifies the dealer 30 and the distributor 40 of the result.

At the time of purchase of the product, the consumer 50 can request the dealer 30 to show evidence that the dealer 30 obtains the authentication of the product. The dealer 30 shows to the consumer 50 evidence that the dealer obtains the authentication of the product. Not only at the time of purchase of a brand-new product but also at the time of transaction of a second-hand product, the consumer 50 can request any dealer 30 to authenticate the product and can request showing of evidence that the dealer obtains the authentication of the product.

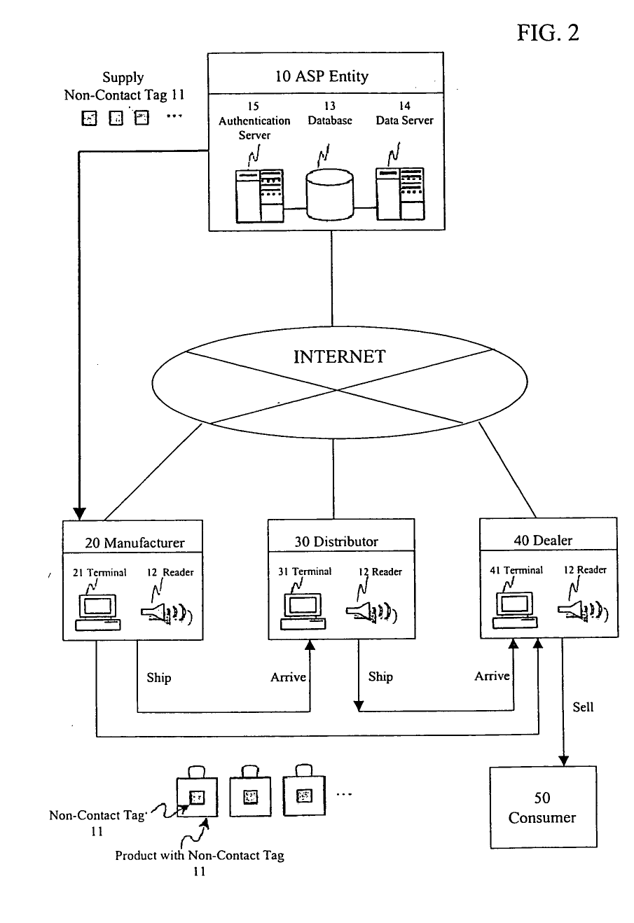

Next, a configuration of hardware which implements the above-described embodiment of the product authentication system according to the present invention is described with reference to FIG. 2.

The ASP entity 10 who provides the product authentication service administers a database 13, a data server 14, and an authentication server 15 for passing data on the Internet.

The manufacturer 20, the dealer 30, and the distributor 40, who are the users of the product authentication service, keep the readers 12 leased from the ASP entity 10, and have general-purpose terminals 21, 31, and 41, such as personal computers, respectively, for connecting the readers 12 to the Internet.

The ASP entity 10 supplies the manufacturer 20 with the non-contact tag 11. The manufacturer 20 ships a product with the non-contact tag 11 embedded therein to the dealer 30 or to the distributor 40.

The dealer 30 and the distributor 40 deal with the product at a distribution stage, and the dealer 30 ultimately sells the product to the consumer 50.

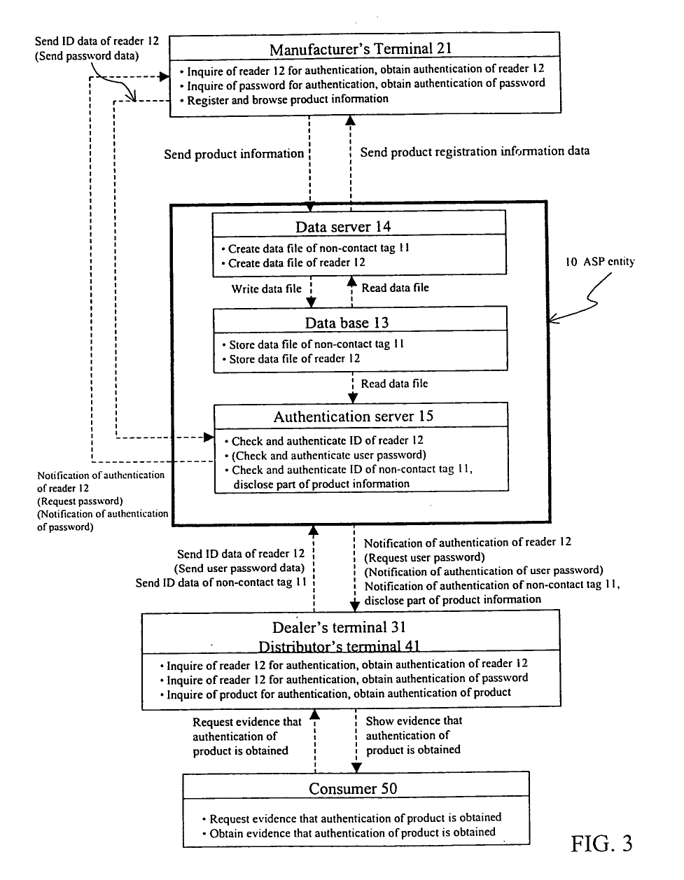

Next, information processing performed by the hardware to implement the embodiment of the product authentication system according to the present invention is described in detail with reference to FIG. 3.

First, registration and browse of the product information by the manufacturer 20 are performed in the following steps.

The manufacturer 20 creates a data file based on the product information such as the name, the date of manufacture, and the place of manufacture of the product manufactured with the non-contact tag 11 embedded therein. The manufacturer 20 connects the reader 12 to the Internet via the terminal 21. The reader 12 sends its own ID data to the authentication server 15. The authentication server 15 checks the received ID data of the reader 12 against the data file of the reader 12 stored in the database 13. If the check tells that they are identical, the authentication server 15 automatically notifies the terminal 21 of the manufacturer 20 that the reader 12 is authenticated.

Further, if a password is assigned, the authentication server 15 requests the password, checks the inputted password data against the data file of the database 13. If the check tells that the they are identical, the authentication server makes a notification that the user is authenticated.

Then, the manufacturer 20 requests the data server 14 to register the product information, and sends the data file of the product information, the product information being related to the ID of the non-contact tag 11. The data server 14 relates the received data file of the product information to the data file of the non-contact tag 11 which is registered in advance to update the data file of the non-contact tag 11, and stores the data file in the database 13.

After the reader 12 is authenticated and the password is authenticated, the manufacturer 20 requests the data server 14 to permit browse of the product information. The data server 14 reads from the database 13 the data file of the non-contact tag 11, and sends the product information data to the manufacturer's terminal 21. The manufacturer 20 browses the product information on the manufacturer's terminal 21.

Next, the obtainment of the authentication of the product by the dealer 30 and by the distributor 40 are performed in the following steps.

First, the dealer 30 and the distributor 40 connect the readers 12 to the Internet via the terminals 31 and 41, respectively. The readers 12 send their own ID data to the authentication server 15. The authentication server 15 checks the received ID data of the readers 12 against the data files of the readers 12 stored in the database 13. If the check tells that they are identical, the authentication server 15 automatically notifies the terminals 31 and 41 of the dealer 30 and the distributor 40, respectively, that the readers 12 are authenticated.

Further, if passwords are assigned, the authentication server 15 requests the passwords, checks the inputted password data against the data files of the database 13. If the check tells that they are identical, the authentication server makes a notification that the users are authenticated.

Then, the dealer 30 and the distributor 40 read with the readers 12 the ID of the non-contact tag 11 embedded in the product for the purpose of making sure that the received product is a genuine product. Then, the authentication server 15 automatically reads the ID of the non-contact tag 11, and checks the ID against the data file of the non-contact tag 11 stored in the database 13. Here, the authentication server 15 may also discriminate whether the product is a counterfeit or not by ascertaining whether the ID of the the non-contact tag 11 relates to the manufacturer 20 who is the supplier If the check tells that they relate to each other, the authentication server 15 automatically notifies the terminals 31 and 41 of the dealer 30 and the distributor 40, respectively, that the non-contact tag 11 is authenticated, and at the same time, discloses thereto a part of the product information such as the model of the product administered as the attribute information. The dealer 30 and the distributor 40 checks the disclosed product information such as the model of the product against the authenticated product to ascertain that the product is a genuine product.

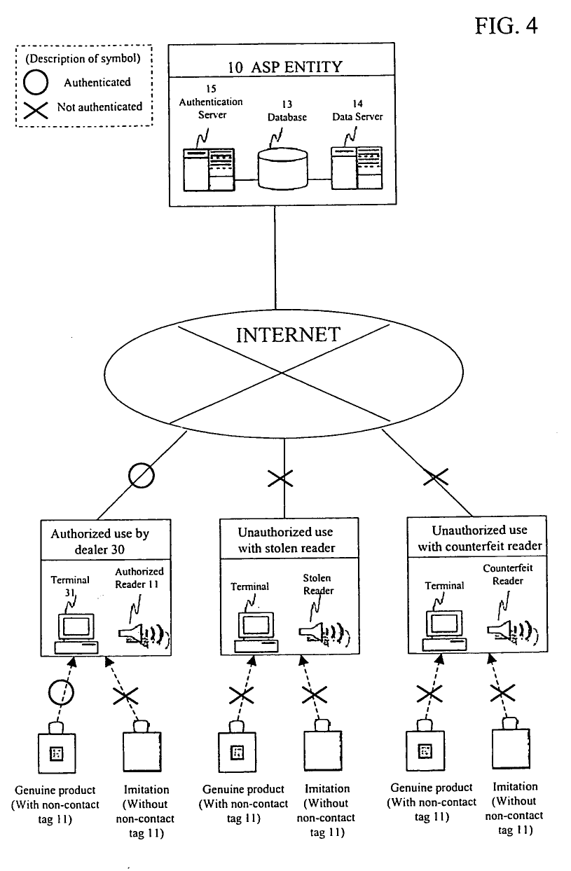

A case where an attempt is made to use the product authentication system without proper authorization is now described with reference to FIG. 4.

First, a case is described where the product authentication system is used with authorization. The reader 12 leased from the ASP entity 10 of the dealer 30 authorized under contract with the ASP entity 10 to obtain the product authentication service can, with the specific ID of the reader 12, automatically obtain authentication of the reader 12. Further, when a password is assigned to the dealer 30 by the ASP entity 10, by checking the password, authentication of the user can be obtained. A genuine product of the dealer 30 can be automatically authenticated by reading with the reader the ID of the non-contact tag 11 embedded in the product. If the product is a counterfeit, since the non-contact tag 11 is not embedded thereto, the product is not authenticated, and thus, a counterfeit can be automatically discriminated.

Next, a case is described where an unauthorized user steals the reader 12 leased to an authorized user from the ASP entity 10 and attempts to use the product authentication system without proper authorization. The unauthorized user can automatically obtain authentication of the reader 12. However, when the ASP entity 10 requires a password, since the unauthorized user does not know the password assigned to the authorized user, the unauthorized user can not input the correct password, and thus, can not obtain authentication of the user. Therefore, an unauthorized user can not obtain the product authentication service.

Further, a case is described where an unauthorized user counterfeits a reader and attempts to use the product authentication system without proper authorization. Even if the unauthorized user connects the counterfeit reader to the Internet, the reader can not be authenticated by the ASP entity 10. Therefore, an unauthorized user can not obtain the product authentication service.

As described in the above, an object of the present invention is to provide a criterion for discrimination between genuine products and counterfeits other than the conventional outer appearance, and to make discriminating work rely not on the conventional visual and manual inspection but on mechanical electronic information processing work. By constructing on the Internet a product authentication system which solves the above object and providing the system in an ASP system as a product authentication service on the Internet to manufacturers, dealers, and distributors forming a distribution channel of the products, accurate discrimination between genuine products and counterfeits in large quantity can be realized at each distribution stage from shipment from a factory of a manufacturer to arrival at a retail store at a low cost, without difficulty, at an arbitrary place, and in a short time.

Further, in the above product authentication system, by making a reader have its specific ID and assigning a specific password to a user for administration, unauthorized use of the product authentication system with a stolen or counterfeited reader can be prevented.

Therefore, counterfeits on the market can be prevented from entering the distribution channel, and benefits can be protected of all the users of the product authentication system from manufacturers manufacturing products, through dealers and distributors dealing the products, and to consumers purchasing the products who are concerned with the products and who form the distribution channel.

While the description above provides a full and complete disclosure of the preferred embodiments of the present invention, various modifications, alternate constructions and equivalents may be employed without departing from the true scope and spirit of the invention.

1. A system for authenticating a product via the Internet comprising:
a non-contact tag embedded as an authentication device in a product to be authenticated, said non-contact tag having a specific ID known only to an administrator of said product authentication system, and said ID being stored in a body of said non-contact tag as electronic data;
a reader for reading ID data of said non-contact tag, said reader having a specific ID known only to said administrator of said product authentication system, said ID being stored in a body of said reader as electronic data, and said reader having means for connecting to the Internet for communication;
a database for storing said ID data and attributes data of said non-contact tag, product information data of said product having said non-contact tag embedded therein, and said ID data and attribute information data of said reader, said database having means for connecting to the Internet for communication;
a data server for reading data stored in said database and for writing data into said database, said data server having means for connecting to the Internet for communication;
an authentication server for checking said ID data of said reader and said ID data of said non-contact tag sent from said reader connected to the Internet against data stored in said database to authenticate said reader and said non-contact tag, said authentication server having means for connecting to the Internet for communication,
said product authentication system further comprising:
means for, prior to distribution of said non-contact tag and said reader to a user of said product authentication system, making said data server read said ID data of said non-contact tag and said ID data of said reader, create data files thereof, and store said data files in said database;
means for, subsequent to the distribution of said non-contact tag and said reader to said user of said product authentication system, making said reader connected to the Internet send its own ID data to said authentication server, and making said authentication server check said received ID data of said reader against said data file of said reader stored in said database;
means for making said authentication server notify said reader checked against said identical ID data that said reader is authenticated, and urge said reader to send said ID data of said non-contact tag embedded in said product;
means for making said authenticated reader read said ID data of said non-contact tag embedded in said product and send said ID data to said authentication server, and making said authentication server check said received ID data of said non-contact tag against said data file of said non-contact tag stored in said database; and
means for making said authentication server notify said reader which sent said ID data of said non-contact tag that said non-contact tag checked against said identical ID data is authenticated.

2. The product authentication system as defined in claim 1, wherein said product authentication system is administered and operated by an application service provider (ASP) to provide product authentication service via the Internet in an ASP system.

3. A product authentication system as defined in claim 1, wherein said product authentication system is a product authentication system where the side of said user is made to have a double ID by assigning to said user of said reader a specific password known only to said administrator and said user of said reader, said product authentication system comprising:
means for making said data server read data of said assigned password, create a data file thereof as attribute information related to said ID data of said distributed reader, and store said data file in said database;
means for, after said reader is notified of its authentication, making said authentication server request input of said password of said user, receive password data inputted and sent from a terminal of said user, and check said password data against said data file stored in said database; and
means for making said authentication server notify said user terminal which sent said password data that said password checked against said identical password data is authenticated.

4. A product authentication system as claimed in claim 1, comprising:
means for making said reader and said user terminal distributed to the manufacturer of the product who is said user of said product authentication system send to said data server product information data such as the name, the model, the date of manufacture, and the place of manufacture of said product, said product information data being related to said ID data of said non-contact tag; and
means for making said data server receive said product information data and create a data file as attribute information related to said ID data of said embedded non-contact tag, and store said data file in said database.

5. A product authentication system as claimed in claim 1, further comprising:
means for making a manufacturer of said non-contact tag create a data file where said ID of said non-contact tag is related to said manufacturer of said product who is a supplier of said non-contact tag, and send said data file to said data server;
means for making said data server receive said data file and store said data file in said database; and
means for making said authentication server receive said ID data of said non-contact tag sent from said reader, and check whether said ID is related to said supplier in said data file of said non-contact tag stored in said database.

6. A system for authenticating a product via the Internet comprising:
a non-contact tag embedded as an authentication device in a product to be authenticated, said non-contact tag having a specific ID known only to an administrator of said product authentication system, and said ID being stored in a body of said non-contact tag as electronic data;
a reader for reading ID data of said non-contact tag, said reader having a specific ID known only to said administrator of said product authentication system, said ID being stored in a body of said reader as electronic data, and said reader having means for connecting to the Internet for communication;
a database for storing said ID data and attributes data of said non-contact tag, product information data of said product having said non-contact tag embedded therein, and said ID data and attribute information data of said reader, said database having means for connecting to the Internet for communication;
a data server for reading data stored in said database and for writing data into said database, said data server having means for connecting to the Internet for communication;
an authentication server for checking said ID data of said reader and said ID data of said non-contact tag sent from said reader connected to the Internet against data stored in said database to authenticate said reader and said non-contact tag, said authentication server having means for connecting to the Internet for communication,
wherein said product authentication system is administered and operated by an application service provider (ASP) to provide product authentication service via the Internet in an ASP system.
